(19) United States
(12) Patent Application Publication
(10) Pub. No.: US 2015/0135733 A1
(43) Pub. Date: May 21, 2015

(54) Inspectable Containers for the Transport by Sea of Compressed Natural Gas, Fitted with a Manhole for Internal Access

(71) Applicants: Francesco Nettis, London (GB); Guiseppe Bergamin, Montanaro (IT); Giulio Carini, Luxembourg (LU); Daniele D'Amelj, Torgiano (IT); Gianfranco Niso, Luxembourg (LU); Paolo Redondi, Milano (IT); Amedeo Silvagni, London (GB); Vanni Neri Tomaselli, Luxembourg (LU)

(72) Inventors: Francesco Nettis, London (GB); Guiseppe Bergamin, Montanaro (IT); Giulio Carini, Luxembourg (LU); Daniele D'Amelj, Torgiano (IT); Gianfranco Niso, Luxembourg (LU); Paolo Redondi, Milano (IT); Amedeo Silvagni, London (GB); Vanni Neri Tomaselli, Luxembourg (LU)

(73) Assignee: BLUE WAVE CO S.A., Luxembourg (LU)

(21) Appl. No.: 14/363,270

(22) PCT Filed: Dec. 5, 2011
(86) PCT No.: PCT/EP2011/071793

§ 371 Date: Nov. 25, 2014

(51) Int. Cl. F17C 13/08

(52) U.S. Cl. CPC F17C 13/082
USPC 62/53.2

(57) ABSTRACT

A CNG transportation vehicle comprising at least one vernally oriented, generally cylindrical, pressure vessel (10) of the type for containing and transporting CNG, the vessel having a generally cylindrical body and two ends and an opening in the form of a manhole at the top end thereof.

The subject of this invention is a new cylindrical container, or pressure vessel, for the transport, by ship, of compressed natural gas, known as CNG. The vessel is designed to contain gas with or without liquids at a pressure that is substantially different from that of the environment, with the peculiarity that it can be inspected through an integrated safety manhole, thus providing reduced access times and therefore reduced costs for the periodical inspections necessary for the maintenance and servicing of the vessels.

### FIELD OF APPLICATION

Fuel gas is conventionally transported by sea principally in the form of LNG, or liquefied natural gas, or in the form of LPG, liquefied petroleum gas. CNG, an acronym for compressed natural gas, was only introduced recently for such transportation. Its composition is similar to LNG, but with CNG, the natural gas is conserved in a gaseous state, although it may contain a liquid fraction. CNG is maintained at high pressures.

The invention applies to the field of the containment and transport of CNG, usually at by sea, with particular reference to large-scale cylindrical containers, generally named pressure vessels, and to the associated inspection and maintenance aspects thereof.

### THE STATE OF THE ART

Known cylindrical containers for compressed natural gas, conventionally called pressure vessels, are produced in various diameters and lengths, in steel or composite materials, and they are especially designed for supporting high pressures and usually for being placed inside the hulls of ships designed for the purpose. Depending on the envisaged stresses occurring in the vessels, the materials used, and the production and handling costs thereof, the most commonly used cylindrical containers for CNG transportation have had a diameter of about 100 cm, when made of steel, and can sometimes reach diameters of 300 cm if made of polymer and composite materials. These containers or vessels are sometimes known as “pipes” or “bottles”.

The typical length of these containers is generally linked to their arrangement inside their ship. For example, the lengths can be substantially the same as the width of the hull, or a part thereof, for example if the cylinders are arranged horizontally, or side by side, or end to end, such as in laterally arranged chambers. Alternatively the lengths can be substantially equal to the height of the hull, or a part thereof, for example if they are arranged vertically, or one above another, or end to end, such as on one or more levels.

In most scenarios, these cylindrical containers are placed side by side in parallel and they are fixed to a plurality of spacer supports that can be especially integrated into or within the hull of the respective ship.

New containers are the subject of research and development by companies operating in the CNG transportation sector for the purpose of increasing efficiency of the transportation of the CNG, for example by increasing the quantity of gas transported safely per journey. For example, some new concepts include the use of new large-scale cylindrical metal vessels, e.g. with a higher diameter than the conventional metal limit of 1 metre. Such vessels may be fabricated to be suitable for supporting the typical pressures of stored CNG. It is also desired to increase the maintainability and lifetime of the containers, by eliminating or reducing the occurance of internal corrosion and by facilitating the inspection and control/service operations thereon, including allowing the use of both visual and electronic inspection/control/service apparatus, and also by permitting expert operators to gain access to the interiors of the vessels.

Some aspects of this invention are known in part in the prior art, albeit with substantially different procedures for use, or different manufacturing technologies and fields of application. For example, openings suitable for permitting access to the interior of cylindrical or spherical containers for liquid and gas, generally made by means of holes fitted with a flanged cylinder, and closed by means of a bolted plate, are known in the art. The following passages set out some examples:

U.S. Pat. No. 6,339,996 (Campbell) describes a system for transporting CNG by sea by means of cylindrical containers arranged vertically and placed side by side with their interaxes staggered to create efficiency during transport. Inspectability by the operator is not envisaged. CN201170437 (Jingmen Hongtu) proposes a horizontal cylindrical container, for liquid at low temperature, inspectable through a manhole inserted inside the external profile of the container at one of the hemispherical ends thereof. CN201214545 (Jiang Baogui) describes a spherical tank for containing a fuel and fitted with a manhole at a top of the tank. CN201507778 (Ni J) proposes an inspectable vertical metal tank with a cylindrical form for containing a corrosive gas at a high temperature, fitted with a manhole at a side of the tank. WO8808822 (Lohr et al.) describes a horizontal double-layer pressure vessel for containing liquid ammonia, fitted with flanged accesses including a manhole at an end of the vessel. CN2924258 (Zhongji) proposes a particular manhole for pressure vessels fitted with a closing plate with a gasket and a compression lever mechanism.

Opening and closing systems suitable for permitting inspection of the interior of containers such as “boilers” and “pressure vessels” are also known and described in technical literature. These openings are conventionally known as “manholes” or “man holes” and, in principle, are coded by international standards such as, for example: ASME BPVC VIII, British Standards BS470, EN 13445, GOST standards, and ATC standards. For example, some important observations regarding the minimum dimensions of the said manhole are made in the aforesaid standards. Those standards, however, do not refer to the specific application of this invention. From the standards it can be deduced that the minimum useful dimension of the said opening must be a diameter of 460 mm if circular or 460 mm×410 mm if oval. Further, a useful minimum diameter of 575 mm is also laid down if it is necessary to access the interior with a breathing apparatus. These rules, however, have generally applied only to small and medium-scale vessels and boilers and the specific context of raw gas or CNG transportation by sea, in large-scale inspectable cylindrical containers, is not mentioned.

Not known, therefore, are large cylindrical containers for transporting CNG, for example containers with diameters equal to or greater than 1 metre and with a height/diameter ratio equal to or greater than 2.5, which specifically permit internal inspection through a dedicated opening of a manhole type in such a way as to permit access within the container by an expert operator with or without electronic service, inspection or control apparatus and assisted breathing devices. In particular, applications of this type are not known by the main companies in the sector such as, for example, Knutsen, Trans Canada, Trans Ocean gas, EnerSea and CeTech.

### Drawbacks

The danger of corrosion and degradation of the internal surface of raw gas and CNG containers is known. Some metal pressure vessels are provided with a protective layer on the inside surface of the vessel. That layer can be created using specific technologies such as, for example, painting, thermal vitrification or plasma deposits. However, they can often degrade with use. Other known solutions envisage multi-layer non-metal containers, made of composite materials, where the first internal layer in contact with the gas is created using impermeable polymer materials which are potentially degradable in the long term.

Another problem with known containers is with inspection techniques—the conventional diagnosis systems applied in the existing CNG framework consists of digital scanning using very costly apparatuses and complex software. Furthermore, most of these operations need to be carried out with the ship dry-docked or on land, and generally only after removing the container from the ship. It follows that it would be considerably more advantageous for a qualified operator to be able to inspect the inside of the container directly on board without dry-docking the ship. This would avoid long waiting times for disconnections and handling operations, thereby reducing ship-downtime.

It would therefore be desirable for companies operating in the CNG transportation sector to create an innovative large pressure vessel suitable for permitting simple and safe access to the inside thereof for allowing inspection thereof by an expert operator who may also be equipped with apparatus for measuring the condition of e.g. the internal surface of the vessel, and potentially also with apparatus for assisted breathing. It would also be desirable to enable access to the inside thereof for carrying out maintenance work such as periodical painting and restoration of an internal surface treatment.

### STATEMENTS OF INVENTION

According to the present invention there is provided a CNG transportation vehicle comprising at least one vertially oriented, generally cylindrical, pressure vessel of the type for containing and transporting CNG, the vessel having a generally cylindrical body and two ends, characterized in that the vessel has an opening in the form of a manhole at the top end thereof.

Preferably the vehicle is a ship.

Preferably the vessel has a generally circular cross section in the horizontal plane.

Preferably the internal diameter of the vessel at that cross section is greater than 1 m.

Preferably that internal diameter is no greater than 6 m.

Preferably the manhole is provided at an inwardly narrowed end of the vessel, that end comprising a bottleneck with an inner wall.

Preferably the thickness of the wall of the bottleneck measured across a horizontal plane is greater than the thickness of the wall of the cylindrical body measured across a parallel horizontal plane in order to compensate for any increase of the stress state at that bottleneck when the vessel is loaded with CNG.

Preferably a portion of the inner wall is defined by a vertically arranged inner wall.

Preferably the vertical wall is formed integrally with the ends of the vessel.

Preferably the vertical wall is formed with a structural continuity with the end at which the manhole is provided.

Preferably the vertical wall is formed with a structural continuity with the cylindrical body.

Preferably the bottleneck has a circular internal cross section in a horizontal plane.

Alternatively the bottleneck has an oval internal cross section in a horizontal plane.

Preferably the bottleneck has a minimum internal diametrical dimension, in a horizontal plane, of at least 40 cm.

Preferably the bottleneck has a minimum internal diametrical dimension, in a horizontal plane, of at least 60 cm. The dimension of 60 cm, i.e. about 24 inches, is generally deemed necessary if the operator is required to lower himself inside with special equipment, such as breathing apparatus and control systems, e.g. if visual inspection is insufficient.

Preferably the manhole on the vessel is obtained by forging, and it forms a monobloc with the structure of the end at which the manhole is provided.

Preferably the manhole includes an outwardly extending flange at the top of a neck of the vessel.

Preferably a manhole cover is provided for sealably closing the manhole.

Preferably the manhole cover is for bolting down onto the end of the vessel.

The pressure vessel can also be provided with an opening for gas loading and offloading, and for liquid evacuation. It is provided at the bottom end and it can be a 12 inch (30 cm) opening for connecting to pipework.

Preferably a plurality of vessels are provided, all arranged in an array.

Preferably the plurality of the pressure vessels are arranged in a ship's hull in modules or in compartments and they can be interconnected, for example for loading and offloading operations, such as via pipework.

Preferably the distance between pressure vessel rows within the modules or compartments will be at least 380 mm, or more preferably at least 600 mm, for external inspection-ability reasons, and to allow space for vessel expansion when loaded with the pressurised gas—the vessels may expand by 2% or more in volume when loaded (and changes in the ambient temperature can also cause the vessel to change their volume).

Preferably the distance between the modules or compartments (or between the outer vessels and the walls or boundaries of the modules or compartments, or between adjacent outer vessels of neighbouring modules or compartments, such as where no physical wall separates neighbouring modules or compartments will be at least 600 mm, or more preferably at least 1 meter, again for external inspection-ability reasons, and/or to allow for vessel expansion.

Preferably each pressure vessel row (or column) is interconnected with a piping system intended for loading and offloading operations.

The or each vessel may be up to 30 m in length, or longer if the hull depth allows that.

The present invention therefore provides a pressure vessel or containers, or a ship or vehicle comprising such a vessel or container, fitted with an inspection trapdoor or manhole that allows direct access by an operator to the inside of the vessel without any need to remove or move the containers themselves.

The trapdoor or manhole can also have appropriate dimensions for an operator to lower himself into the pressure vessel and carry out all the maintenance operations required during the normal course of the product transport activity which also envisages stoppages for even more thorough checks.

The design can be provided to comply with the main international standards governing such objects.

The manhole can be described briefly as a flanged tube to which a cover will be fixed at one end while the other end will be a structural continuity of the pressure vessel.

In the case of pressure vessels made of steel only, this end will be welded or forged in accordance with the procedures accepted by the main international standards. See FIGS. 7 and 8.

In the case of pressure vessels with the structural part in composite and an internal liner, the geometry of this manhole may be different from the previous one, envisaging inclined wall profiles, as in FIGS. 9 to 11 or complete wrapping as in FIG. 6. As such the present invention also is capable of permitting better or more efficient depositing of the fibres during the winding stage when manufacturing the unit than known hoop-wrapped arrangements where only the cylindrical body is wrapped. For example, these oblique profiles permit better anchoring of the manhole to the structural part in composite, even during the product usage stage.

### SCOPES/ADVANTAGES

Reduction of the inspection times envisaged by the regulations in force.
Greater accuracy of the inspections of the internal lining of the container.
Possibility of maintenance operations on the internal lining while the ship is in service by isolating the pressure vessels with the closure of appropriate valves in order to work in complete safety.
No container disassembly and/or handling operation.
No disassembly and/or handing operations on the interpiping and valve system.
Possibility of carrying out all the controls requested by the regulations in situ which would otherwise be impossible without internal access.
Reduction of the costs for handling the system and of the stand-down times during dry-docking.
A monobloc form with the vessel.
Fewer risks of defective welds and better distribution of the stresses in the neck.
Simplicity of use and reduced maintenance times.
Ready to use with integrated mechanical safety systems.

### CONTENTS OF THE DRAWINGS

These and other features of the present invention will now be described in greater detail with reference to the accompanying drawings, in which:

FIG. 1 shows a schematic cross section through a hull of a ship comprising a plurality of vertial vessels;

FIG. 2 schematically shows the constrol piping of the ship of FIG. 1;

FIGS. 3, 4 and 5 schematically show a module of vessels;

FIG. 6 schematically shows a composite wrapped vessel in cross section;

FIGS. 7 and 8 schematically show a metal pressure vessel in cross section; and

FIGS. 9, 10 and 11 schematically show a composite pressure vessel in cross section;

### PRACTICAL EXECUTION OF THE INVENTION

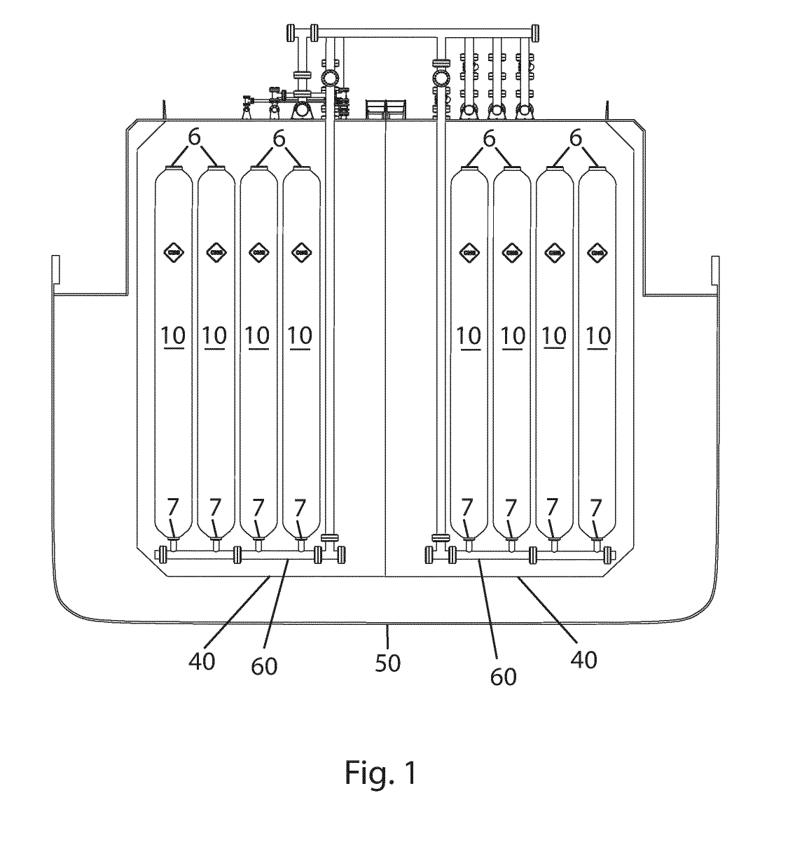

The subject of this invention, an example of which is shown in FIG. 1, is a new containment and transportation system for gas in CNG form by means of cylindrical containers 10 of the inspectable pressure vessel type. As shown there are preferably arranged on a ship—within the hull 50 thereof.

In a preferable, non-exclusive embodiment the containers 10 are arranged vertically and have a 12-inch opening 7 in the bottom end for filling and discharging fluids. This configuration also makes it possible to discharge liquids if there is condensate inside the container 10.

Also provided is an opening 6 of the manhole type at the top for inspection. With this it is easy for an operator to access the inside of the vessel 10 in order to inspect or service the internal surface of the vessel 10, which internal surface is liable to damage mainly as a result of the corrosive nature of CNG. For example, the manhole 6 allows the carrying out of any maintenance operations such as, for example, internal painting, restoration and internal lining work in general, and also operations for checking and inspecting the structural integrity of the container by means of non-destructive tests (NDT).

The opening or openings 6, 7 can be made with a continuity in the container's structure, such as by using forging, or providing a monobloc, or by welding appropriate components at the end(s).

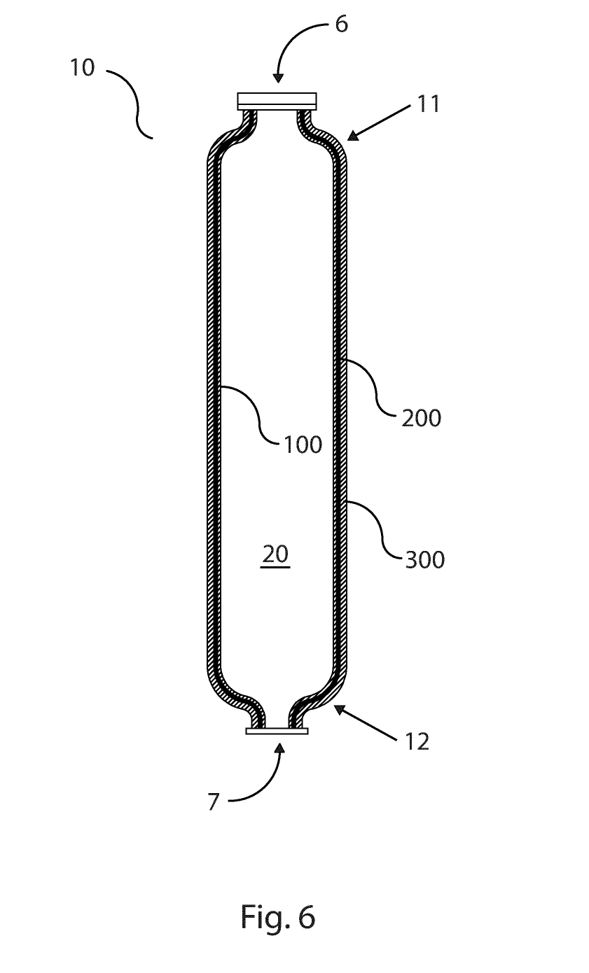

Referring to FIG. 6, a first embodiment of vessel 10 is shown in greater detail. It is made of an internal liner, usually a metal, that provides at least a first layer 200 capable of hydraulic or fluidic containment of raw gases such as CNG 20. Wrapped around that first layer 200 is at least one additional layer, such as an external composite layer 300.

Said first layer 200 is not needed to be provided in a form to provide a structural aim during CNG transportation, in particular such as during sea or marine transportation, or during loading and offloading phases. However, it is preferred that it should be at least corrosion-proof. Further it is preferred for it to be capable of carrying non-treated or unprocessed gases. Hence the preferred material is a stainless steel, or some other metallic alloy.

This construction also allows the tank to be able to carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

The stainless steel is preferably an austenitic stainless steel such as AISI 304, 314, 316 or 316L (with low carbon percentages). Where some other metallic alloy is used, it is preferably a Nickel-based alloy or an Aluminum-based alloy, such as one that has corrosion resistance.

If a carbon steel liner is used, a cladding process or a thermal spray process are possible to treat the the inner part of the liner in contact with the gas, so that an additional corrosion-resistant layer is added on a more common and economical substrate. These additional processes are only possible having a large-diameter opening in one of the ends of the pressure vessel.

The metallic liner forming the first layer 200 preferably only needs to be strong enough to withstand stresses arising from manufacturing processes of the vessel, so as not to collapse on itself, such as those imposed thereon during fiber winding. This is because the structural support during pressurized transportation of CNG 20 will be provided instead by the external composite layer 300.

The external composite layer 300, which uses at least one fiber layer, will be a fiber-reinforced polymer. The composite layer can be based on glass, or on carbon/graphite, or on aramid fibers, or on combinations thereof, for example. The external composite layer is used as a reinforcement, fully wrapping the pressure vessels 10, including vessel ends 11, 12, and providing the structural strength for the vessel during service. In case of glass fibers, is it preferred but not limited to the use of an E-glass or S-glass fiber. Preferably, however, the glass fiber has a suggested tensile strength of 1,500 MPa or higher and/or a suggested Young Modulus of 70 GPa or higher. In case of carbon fibers, is it preferred but not limited to the use of a carbon yarn, preferably with a tensile strength of 3,200 MPa or higher and/or a Young Modulus of 230 GPa or higher. Preferably there are 12,000, 24,000 or 48,000 filaments per yarn.

The composite matrix is preferred to be a polymeric resin thermoset or thermoplastic. If a thermoset, it may be an epoxy-based resin.

The manufacturing of the external composite layer 300 over the said first layer 200 preferably involves a winding technology. This can potentially gives a high efficiency in terms of production hours. Moreover it can potentially provide good precision in the fibers' orientation. Further it can provide good quality reproducibility.

The reinforcing fibers preferably are wound with a back-tension over a mandrel. The mandrel is typically the liner. The liner thus constitutes the male mould for this technology. The winding is typically after the fibers have been pre-impregnated in the resin. Impregnated fibers are thus preferably deposed in layers over said metallic liner until the desired thickness is reached for the given diameter. For example, for a diameter of 6 m, the desired thickness might be about 350 mm for carbon-based composites or about 650 mm for glass-based composites.

Since this invention preferably relates to a substantially fully-wrapped pressure vessel 10, a multi-axis crosshead for fibers is preferably used in the manufacturing process.

The process preferably includes a covering of the majority of the ends 11, 12 of the pressure vessel 10 with the structural external composite layer 300.

In the case of the use of thermoset resins there can be a use of an impregnating basket before the fiber deposition—for impregnating the fibers before actually winding the fibers around the liner 200.

In the case of the use of thermoplastic resins, there can be a heating of the resin before the fiber deposition in order to melt the resin just before reaching the mandrel, or the fibers are impregnated with thermoplastic resin before they are deposited as a composite material on the metal liner. The resin is again heated before depositing the fibers in order to melt the resin just before the fiber and resin composite reaches the liner 200.

The liner 200 may be coated 100 on an inside wall to improve the corrosion resistance thereof.

The pressure vessel 10 is provided with an opening 7 (here provided with a cap or connector) for gas loading and offloading, and for liquid evacuation. It is provided at the bottom end 12 and it can be a 12 inch (30 cm) opening for connecting to pipework.

The vessel also has an opening 6 at the top end 11 and it is in the form of a manhole. Preferably it is at least an 18 inch (45 cm) wide access manhole, such as one with a sealable cover (or more preferably a 24 inch (60 cm) manhole). Preferably it fulfills ASME standards. It is provided with closing means for allowing sealed closing of the opening, such as by bolting a manhole cover down onto the manhole opening.

The manhole allows internal inspection of the vessel 10, such as by a person climbing into the vessel.

The neck of the manhole includes a vertically internal extending wall portion.

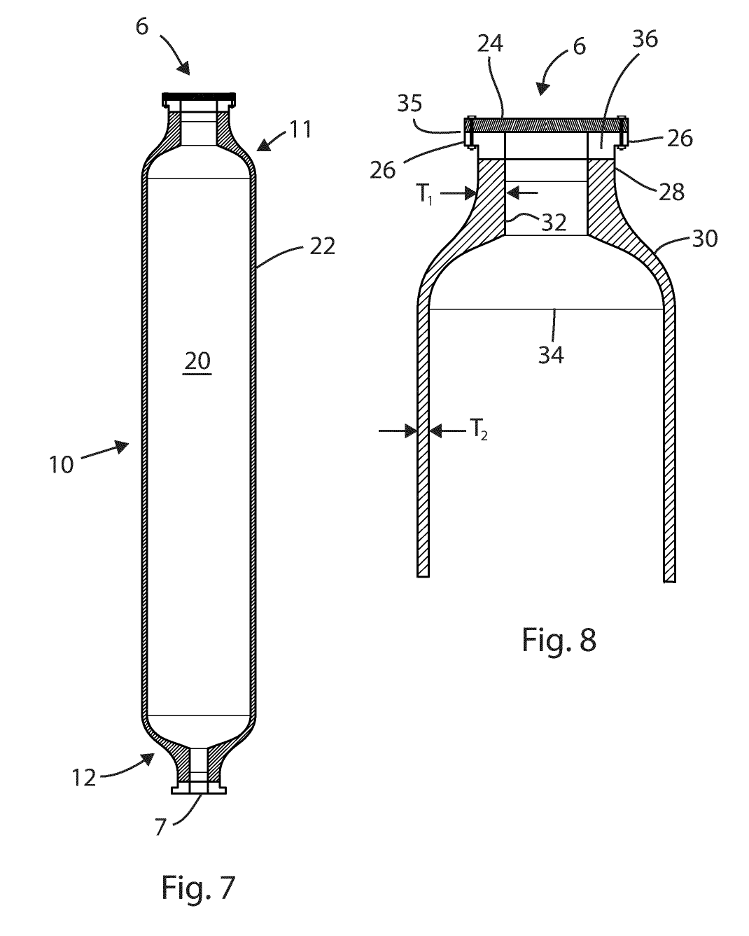

Referring next to FIGS. 7 and 8, an alternative design of pressure vessel 10 is shown. The vessel again is designed to contain CNG 20, and it has a top end 11 and a bottom end 12. The bottom end again has an opening 7 for connection to pipework (not shown), which opening may again be a 12 inch (30 cm) opening. Further, the top end has a manhole 6. This embodiment, however, has a steel cylindrical body 22, and steel ends 11, 12.

Again the vessel has a manhole cover 24, and in this example it is illustrated to be bolted down over a flanged end of the manhole 6—the bolts extend through outwardly extended flanges 26 on the free end of the neck 28 of the vessel 10.

The neck 28 in this embodiment has a vertical neck portion, or concave portion, on an external wall. This thus provides a section wherein a wall thickness of the neck 28 can be measured in a horizontal plane. In that regard, the neck 28 has a thickness T₁ measured in a horizontal plane that is thicker than the thickness T₂ of the sidewalls of the body also measured in a parallel horizontal plane. The former horizontal plane is preferably just below the flange—in the portion with the externally concave or vertical neck portion—an area prior to any substantial widening of the neck as it blends with the end cap 30 of the vessel 10. The latter horizontal plane is preferably measured at a mid-region of the cylindrical body 22.

The neck 28 also features an internal wall 32 defining the opening-size of the manhole. That internal wall 32, as shown, is vertically arranged. This embodiment has the preferred feature of that internal vertical wall extending along substantially the majority of the extent of the vessel's top end 11, i.e. at least 50% thereof, measured from the point or line 34 of commencement of the reduction in internal cross section to the point or line 35 of attachment of the manhole cover 24. Preferably the internal wall is vertical for at least 60% of that extent.

The manhole's flanged end-cap 36 is shown here to be formed separate to the necked portion of the main body of the vessel 10, and it is here welded onto an end wall of that necked portion. It is possible, however, for the end-cap 35 to be forged onto the necked portion, thus being an integral part of the end 11.

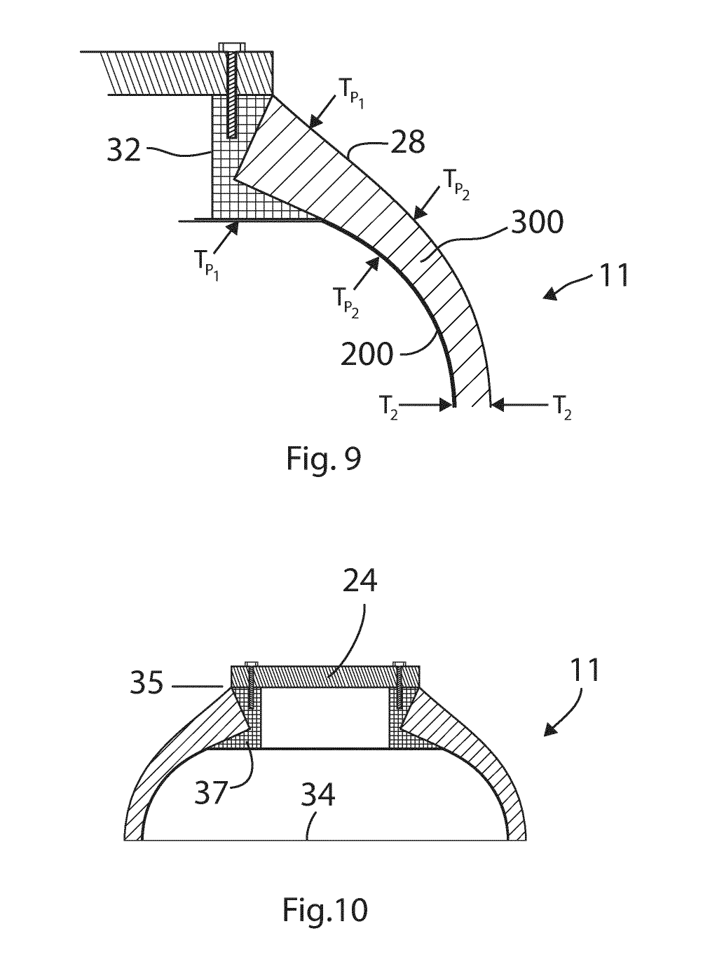

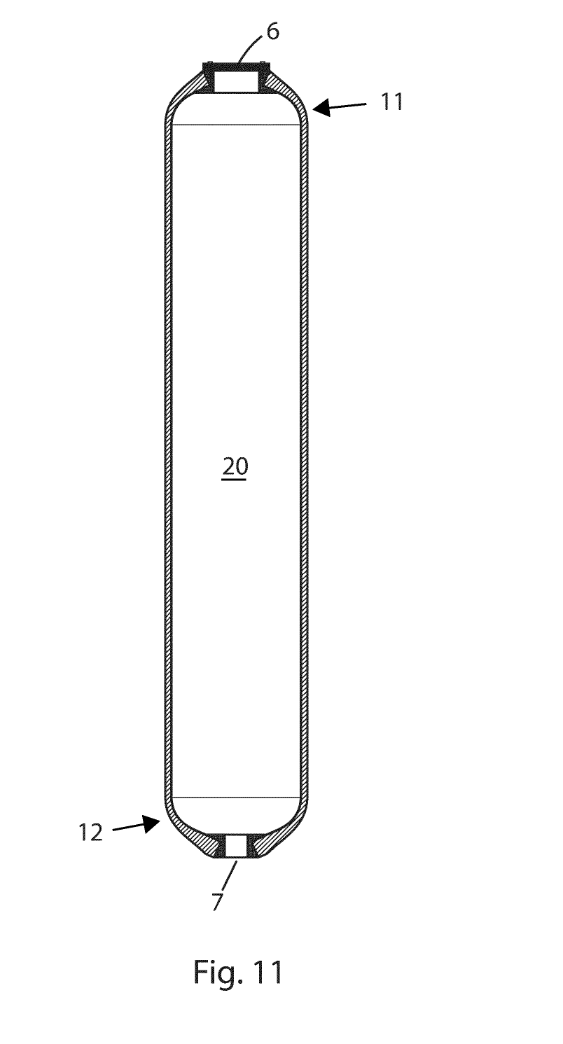

Referring next to FIGS. 9 to 11, a third embodiment of vessel is disclosed. This vessel, as shown in FIG. 11, has many similar features to that of FIG. 11, including it being designed to contain CNG 20, and it having a top end 11, a bottom end 12, an opening 7 in the bottom end 12 for connection to pipework (not shown), which opening may again be a 12 inch (30 cm) opening. Further, the top end 11 has a manhole 6. This embodiment, however, has a composite structure with similarities in many respects to that of FIG. 6. For example, as shown in FIG. 9 there is a liner 200 over-wound with a composite outer layer 300.

Further, there is again the cylindrical body 22, and a manhole cover 24. however, in this embodiment the cover 24 is bolted or screwed down onto a non-flanged neck of the end 11. The bolts or screws therefore tighten down into blind holes.

The neck 28 in this embodiment has no external vertical neck portion. Neither does it have an externally concave portion. The appearance of the neck in this embodiment is therefore more compact than the previous embodiments. The absence of that vertical or concave neck portion makes a neck thickness measured in a horizontal plane relatively ineffective in terms of use for comparison with a thickness of the wall of the cylindrical body. A thickness of the neck measured perpendicular to the outer wall of the vessel is therefore a more preferred measurement for the thickness of the neck in this embodiment. That thickness Tₚ is illustrated to be bigger than the thickness T₂ of the sidewalls of the body, which is still measured in a horizontal plane—preferably measured at a mid-region of the cylindrical body, but shown in FIG. 9 at a top-region thereof. In this embodiment Tₚ can be measured along the entirety of the neck 28 and still be bigger than T₂.

The neck 28 again features an internal wall 32 defining the opening-size of the manhole 6. That internal wall 32, as shown, is vertically arranged. This embodiment has that internal vertical wall extending along at least 30% of the extent of the vessel's top end 11. For this squatter appearance of end, that 30% is seen to be a desireable feature. The extent is measured again from the point or line 34 of commencement of the reduction in internal cross section to the point or line 35 of attachment of the manhole cover 24.

The manhole's structure, in this embodiment, is formed from a two-part tapering or dovetailing shape. There is the end cap 11 of the vessel which is unitarily formed with the cylindrical body 22, and a plug member 37 that fits with and joins to the internally facing profile of that end cap 11. As shown in cross section in FIG. 10, that fit is in the form of a dovetail-design so that pressure within the vessel cannot force out the plug member 37, and likewise efforts to connect the manhole cover 24 cannot push the plug member 37 into the inside of the vessel. The dovetail thus features dual opposing tapered faces.

The plug member is formed of a composite material and is formed into the end of the end cap 11 prior to the resin setting.

By using a common composite or resin between the end cap 11 and the plug member 37, the resulting form can be effectively an integrated or seamless joint.

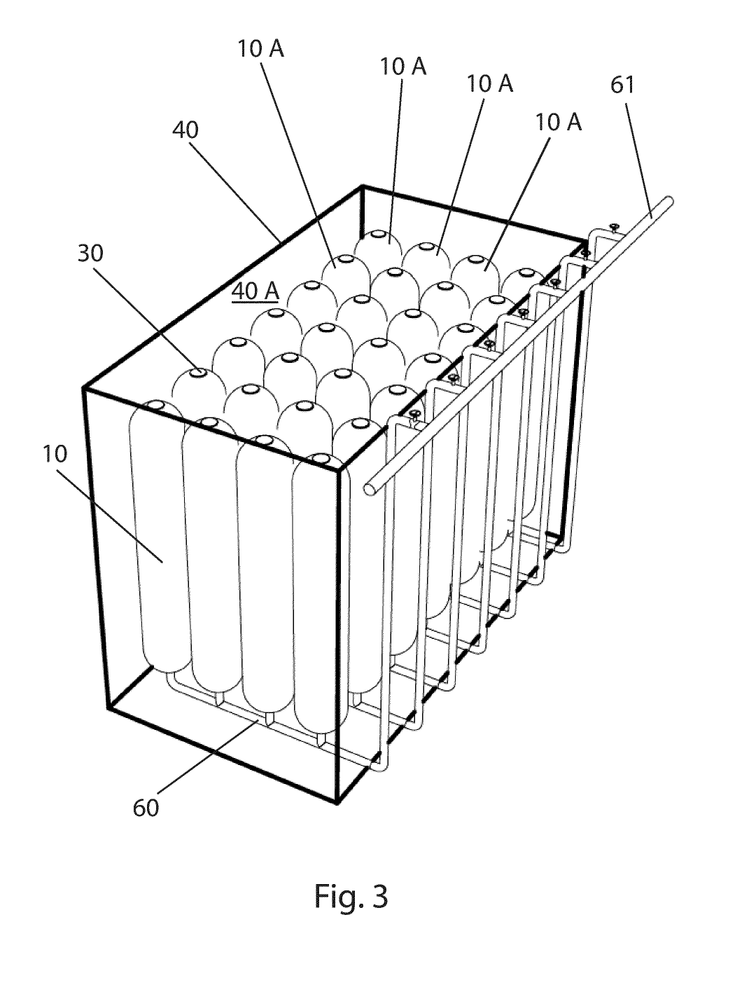

Referring now to FIG. 3, a plurality of the pressure vessels 10 are arranged in a ship's hull (see FIG. 1) in modules or in compartments 40 and they can be interconnected, for example for loading and offloading operations, such as via pipework 61.

In the preferred configuration, the modules or compartments 40 have four edges (i.e. they are quadrilateral-shaped) and contain a plurality of vessels 10. The number of vessels chosen will depend upon the vessel diameter or shape and the size of the modules or compartments 40. Further, the number of modules or compartments will depend upon the structural constraints of the ship hull for accommodating the modules or compartments 40. It is not essential for all the modules or compartments to be of the same size or shape, and likewise they need not contain the same size or shape of pressure vessel, or the same numbers thereof.

The vessels 10 may be in a regular array within the modules or compartments—in the illustrated embodiment a 4×7 array. Other array sizes are also to be anticipated, whether in the same module (i.e. with differently sized pressure vessels), or in differently sized modules, and the arrangements can be chosen or designed to fit appropriately in the ship's hull.

Preferably the distance between pressure vessel rows within the modules or compartments will be at least 380 mm, or more preferably at least 600 mm, for external inspection-ability reasons, and to allow space for vessel expansion when loaded with the pressurised gas—the vessels may expand by 2% or more in volume when loaded (and changes in the ambient temperature can also cause the vessel to change their volume).

Preferably the distance between the modules or compartments (or between the outer vessels 10A and the walls or boundaries 40A of the modules or compartments 40, or between adjacent outer vessels of neighbouring modules or compartments 40, such as where no physical wall separates neighbouring modules or compartments 40 will be at least 600 mm, or more preferably at least 1 m, again for external inspection-ability reasons, and/or to allow for vessel expansion.

Each pressure vessel row (or column) is interconnected with a piping system 60 intended for loading and offloading operations. The piping 60 is shown to be connected at the bottom of the vessels 10. It can be provided elsewhere, but the bottom is preferred.

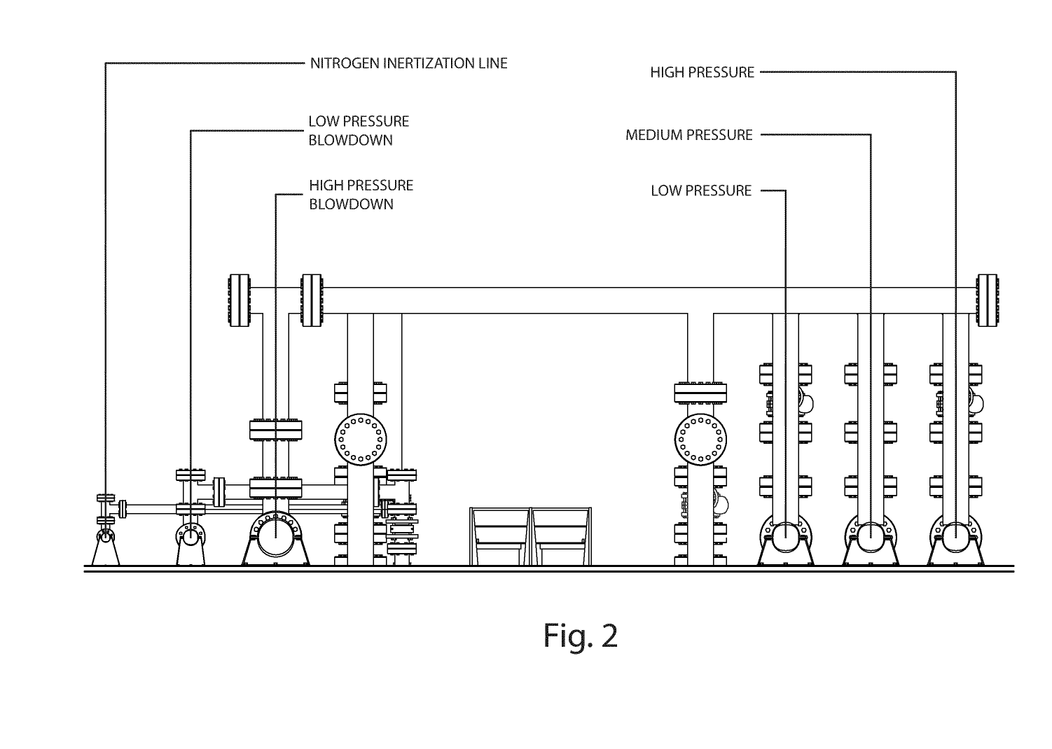

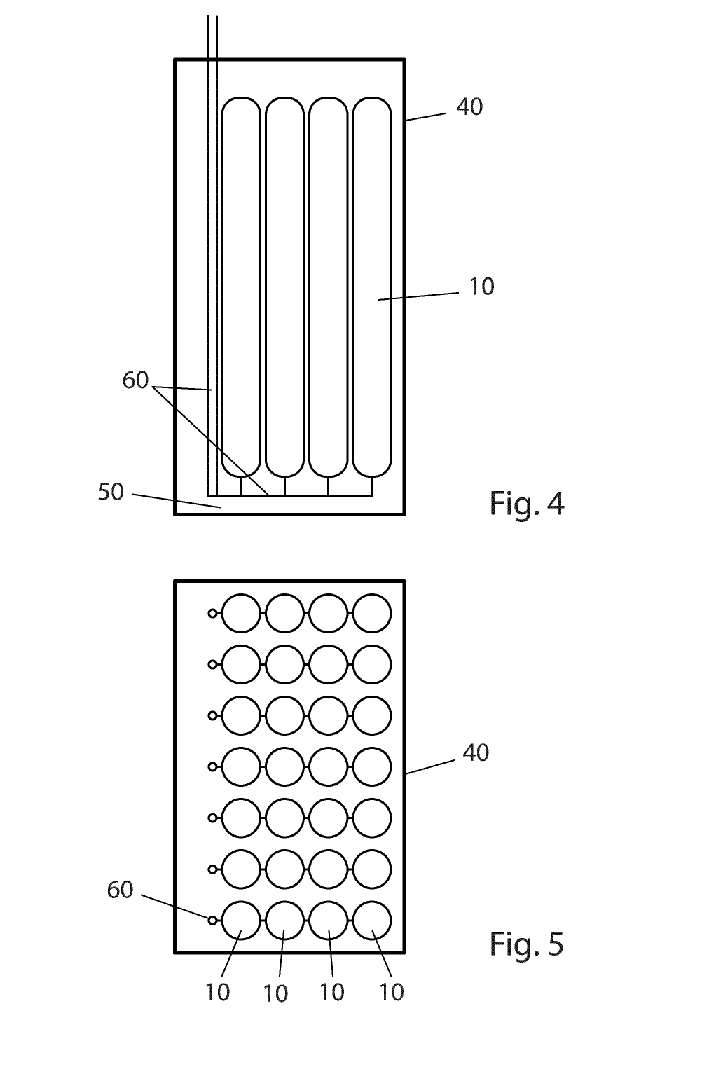

In a preferred arrangement, the piping connects via the 12 inch (30 cm) opening 7 at the bottom 12 of the vessel 10. The connection is to main headers, and preferably through motorized valves. The piping is schematically shown, by way of an example, in FIG. 3, FIG. 4 and FIG. 5. See also FIGS. 1 and 2.

The main headers can consist of various different pressure levels, for example three of them (high—e.g. 250 bar, medium—e.g. 150 bar, and low—e.g. 90 bar), plus one blow down header and one nitrogen header for inert purposes.

The vessels 10 are mounted vertically, such as on dedicated supports or brackets, or by being strapped into place. The supports (not shown) hold the vessels 10 in order to avoid horizontal displacement of the vessels relative to one another. Clamps, brackets or other conventional pressure vessel retention systems, may be used for this purpose, such as hoops or straps that secure the main cylinder of each vessel.

The supports can be designed to accommodate vessel expansion, such as by having some resilience.

Vertically-mounted vessels have been found to give less criticality in following dynamic loads due to the ship motion and can allow an easier potential replacement of single vessels in the module or compartment—they can be lifted out without the need to first remove other vessels from above. This arrangement also allows a potentially faster installation time. Mounting vessels in vertical position also allows condensed liquids to fall under the influence of gravity to the bottom, thereby being off-loadable from the vessels, e.g. using the 12 inch opening 7 at the bottom 12 of each vessel 10.

Offloading of the gas will be also from the bottom of the vessel 10.

With the majority of the piping 60 positioned towards the bottom of the modules/bottom of the vessels, this positions the center of gravity also in a low position, which is recommended or preferred, especially for improving stability at sea, or during gas transportation.

Modules or compartments 40 can be kept in a controlled environment with nitrogen gas being between the vessels 10 and the modules' walls 40A, thus helping to prevent fire occurrence or fire hazard. Alternatively, the engine exhaust gas could be used for this inerting function thanks to its composition being rich in CO₂.

Maximization of the size of the individual vessels 10, such as by making them up to 6 m in diameter and/or up to 30 m in length, reduces the total number of vessels needed for the same total volume contained. Further it serves to reduce connection and interpiping complexity. This in turn reduces the number of possible leakage points, which usually occur in weaker locations such as weldings, joints and manifolds. Preferred arrangements call for diameters of at least 2 m.

A ship may comprise multiple modules, such as an array of modules. One dedicated module can be set aside for liquid storage (condensate) using the same concept of interconnection used for the gas storage. The modules are thus potentially all connected together to allow a distribution of such liquid from other modules 40 to the dedicated module—a ship will typically feature multiple modules.

In and out gas storage piping is linked with metering, heating and blow down systems and scavenging systems, e.g. through valved manifolds. They can be remotely activated by a Distributed Control System (DCS).

Piping diameters are preferably as follows:

18 inch. for the three main headers (low, medium and high pressure) dedicated to CNG loading/offloading.

24 inch. for the blow-down CNG line.

6 inch. for the pipe feeding the module with the inert gas.

10 inch. for the blow-down inert gas line.

10 inch. for the pipe dedicated to possible liquid loading/offloading.

All modules are typically equipped with adequate firefighting systems, as foreseen by international codes, standards and rules.

The transported CNG will typically be at a pressure in excess of 60 bar, and potentially in excess of 100 bar, 150 bar, 200 bar or 250 bar, and potentially peaking at 300 bar or 350 bar.

The pressure vessels described herein can carry a variety of gases, such as raw gas straight from a bore well, including raw natural gas, e.g. when compressed—raw CNG or RCNG, or H2, or CO2 or processed natural gas (methane), or raw or part processed natural gas, e.g. with CO2 allowances of up to 14% molar, H2S allowances of up to 1,000 ppm, or H2 and CO2 gas impurities, or other impurities or corrosive species.

The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C2H6, C3H8, C4H10, C5H12, C6H14, C7H16, C8H18, C9+ hydrocarbons, CO2 and H2S, plus potentially toluene, diesel and octane in a liquid state, and other to impurities/species.

The present invention has been described above purely by way of example. Modifications in detail may be made to the invention within the scope of the claims appended hereto.

1. A CNG transportation vehicle comprising at least one vertically oriented, generally cylindrical, pressure vessel of the type for containing and transporting CNG, the vessel having a generally cylindrical body and two ends, characterized in that the vessel has an opening in the form of a manhole at the top end thereof.

2. The vehicle of claim 1, wherein the vehicle is a ship.

3. The vehicle of claim 1, wherein the vessel has a generally circular cross section in the horizontal plane.

4. The vehicle of claim 3, wherein the internal diameter of the vessel at that cross section is greater than 1 m.

5. The vehicle of claim 4, wherein that internal diameter is no greater than 6 m.

6. The vehicle of claim 1, wherein the manhole is provided at an inwardly narrowed end of the vessel, that end comprising a bottleneck with an inner wall.

7. The vehicle of claim 6, wherein the thickness of the wall of the bottleneck measured across a horizontal plane is greater than the thickness of the wall of the cylindrical body measured across a parallel horizontal plane.

8. The vehicle of claim 6, wherein a portion of the inner wall is defined by a vertically arranged inner wall.

9. The vehicle of claim 8, wherein the vertical wall is formed integrally with the ends of the vessel.

10. The vehicle of claim 8, wherein the vertical wall is formed with a structural continuity with the end at which the manhole is provided.

11. The vehicle of claim 10, wherein the vertical wall is formed with a structural continuity with the cylindrical body.

12. The vehicle of claim 6, wherein the bottleneck has a circular or an oval internal cross section in a horizontal plane.

13. (canceled)

14. The vehicle of claim 6, wherein the bottleneck has a minimum internal diametrical dimension, in a horizontal plane, of at least 40 cm, or, more particularly, or at least 60 cm.

15. (canceled)

16. (canceled)

17. The vehicle of claim 1 wherein the manhole on the vessel is formed as a monobloc with the structure of the end at which the manhole is provided.

18. The vehicle of claim 1, wherein the manhole includes an outwardly extending flange at the top of a neck of the vessel.

19. The vehicle of claim 1, wherein a manhole cover is provided for sealably closing the manhole.

20. (canceled)

21. The vehicle of claim 1, wherein the pressure vessel is provided with a second opening, the second opening being for gas loading and offloading, and for liquid evacuation.

22. The vehicle of claim 17, the second opening being provided at the bottom end of the vessel.

23. (canceled)

24. The vehicle of claim 1 wherein the vessel has an overall length of up to 30 m.

25. The vehicle of claim 1, wherein a plurality of said vessels are provided.

26. The vehicle of claim 20, wherein the distance between neighbouring pressure vessels is at least 380 mm.

27. The vehicle of claim 20, wherein the plurality of the pressure vessels are arranged in a ship's hull in modules or in compartments.

28. The vehicle of claim 22, wherein the distance between the outer vessels within the modules or compartments and the walls or boundaries of the modules or compartments is at least 600 mm.
